(19) United States
(12) Patent Application Publication
(10) Pub. No.: US 2017/0329748 A1
(43) Pub. Date: Nov. 16, 2017

(54) METHOD AND SYSTEM FOR EDITING HYPERLINK IN A THREE-DIMENSIONAL SCENE

(71) Applicant: FRAMY INC., GRAND CAYMAN (KY)

(72) Inventor: YU-HSIEN LI, TAIPEI CITY (TW)

(21) Appl. No.: 15/212,101

(22) Filed: Jul. 15, 2016

(30) Foreign Application Priority Data
May 11, 2016 (TW) 105114564

(51) Int. Cl. G06F 17/22; G06F 3/0488; G06F 3/0481; G06T 19/00; G06F 3/01

(52) U.S. Cl. CPC G06F 17/2235; G06T 19/006; G06F 3/017; G06F 3/04815; G06F 3/0488

(57) ABSTRACT

The disclosure is related to a method and a system for editing hyperlink in a three-dimensional scene. The method is applicable to a smart device. An application program executed in the smart device is used to process the hyperlink editing method. The smart device first displays a three-dimensional scene corresponding to a position within a space. Three-dimensional positioning signals within this space are produced when the smart device is moved to a specific position. A touch display allows a user to specify a position through touch signals so as to establish a hyperlink associated to this position. At this moment, the program prompts the user to establish a hyperlink. The scene and the position information of the hyperlink can be stored to a memory of the smart device. The program also allows the user to browse the scene and link to the associated content via the hyperlink.

### BACKGROUND OF THE INVENTION

### 1. Field of the Invention

The present invention is generally related to a technology of creating hyperlink in a three-dimensional scene, more particularly to an editing method and a system for creating hyperlink within the three-dimensional scene using a mobile device.

### 2. Description of Related Art

A traditional web page is built by a kind of script language such as HTML, and some functions can be added to the web page through background scripts. Further, a hyperlink tag embedded in the web page allows a user easily to link to another web page, or to open or download a file. The hyperlink can also trigger a specific software program. The conventional hyperlink is an HTML-based tag script embedded to a web page by using a web editor or a text editor.

In the technology for viewing a panoramic scene, an intelligent device, e.g. a smart phone or virtual-reality glasses (VR glasses) can be utilized to view a virtual space. The virtual space is such as three-dimensional virtual space. The conventional 3D virtual space usually indicates a single scene provided for the user to browse using the intelligent device. The content within the conventional single virtual space is always un-editable since it has been produced by the manufacturer who developed the scene.

When an intelligent device such as the mobile phone or VR glasses is used to browse the virtual space, only a single scene is provided. Few of them provide any links allowing the viewer to link to another scene or content. If the conventional virtual scene has any link, the link is still for in-content linking. The conventional technology provides no way for the user to establish any link for linking to other space or content.

### SUMMARY OF THE INVENTION

The disclosure in accordance with the present invention is related to a method and a system for editing hyperlink within a three-dimensional scene, hereinafter ‘3D scene’. One of the objectives of the present invention is to allow a user to himself manipulate an intelligent device to intuitively edit and/or create hyperlink within a 3D scene. The user can browse the 3D scene and simultaneously be prompted to touch any hyperlink within the 3D scene to link to other content. The hyperlink is associated to linking a web page, linking another 3D scene, linking a correlated 3D scene within the 3D scene, linking multimedia content, executing a program, activating an animation, or producing a message.

In one embodiment, the method for editing hyperlink within the 3D scene is particularly implemented by an application program inside the intelligent device. Through the application program, a series of steps are performed, including generating positioning signals within a space by moving the intelligent device, using the intelligent device to display a range of the 3D scene corresponding to positioning signals, acquiring position information of a specified position within the 3D scene, and next creating a hyperlink in respect to the specified position.

In the foregoing description, the positioning signals can be generated through a gyroscope of the intelligent device when the intelligent device moves in a space. The position information of a specified position can be acknowledged through touch signals generated by a touch-sensitive display of the intelligent device. After that, a hyperlink option can be provided around the specified position for creating the hyperlink. The option allows a user to make a selection of the hyperlink for linking to further content.

According to one of the embodiments, the system is applied inside an intelligent device. A plurality of functional modules of the system are implemented by software and/or hardware. In the system, a 3D space positioning module is provided to acquire positioning signals from the intelligent device which moves within a space, an image processing module is provided for processing the 3D scene corresponding to the positioning signals in the space, displaying the 3D scene corresponding to the positioning signals, rendering the image signals associated to the hyperlink, where a display module is used to simultaneously display the 3D scene in response to the positioning signals based on a display resolution of the device, a touch-sensitive module is provided for specifying a position with respect to the hyperlink within the 3D scene, and a hyperlink editing module is used to process the functions of editing the hyperlink when a position associated to the hyperlink is confirmed. The display module is to display the specified position associated to the hyperlink. Finally, a storage module is used to store the 3D scene, and every hyperlink associated to every specified position.

In one further embodiment, the storage module also stores an instruction set and a processor performs the method for editing hyperlink in the intelligent device. The instruction set includes instructions for generating positioning signals by the intelligent device; instructions for displaying the 3D scene corresponding to the positioning signals; instructions for acquiring position information of the specified position within the 3D scene; and instructions for creating the hyperlink at the specified position.

In one more embodiment, the editing instruction set also includes using a file to record correlation between every specified position within the 3D scene and its corresponding hyperlink. Moreover, after finishing all hyperlinks editing in the 3D scene, a playback file is outputted after re-coding the 3D scene where all hyperlinks within the 3D scene are confirmed.

### BRIEF DESCRIPTION OF THE DRAWINGS

FIG. 1A and FIG. 1B show a schematic diagram describing a circumstance using an intelligent device to perform a hyperlink editing method within a 3D scene according to one embodiment of the present invention;

FIGS. 2A, 2B and 2C schematically show a series of screen shots depicting using the intelligent device to implement the hyperlink editing method within the 3D scene in one embodiment of the present invention;

FIG. 3 shows a diagram of functional blocks depicting the hyperlink editing system according to one embodiment of the present invention;

FIGS. 4A, 4B and 4C schematically show a series of screen shots depicting using the intelligent device to browse a 3D scene produced by the hyperlink editing method in one embodiment of the present invention;

FIG. 5 shows a flow chart depicting the method of editing hyperlink in a 3D scene in one embodiment of the present invention;

FIG. 6 shows another flow chart depicting the method of editing hyperlink in a 3D scene in one embodiment of the present invention;

FIG. 7 shows a flow chart to browse the 3D scene in embodiment of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The disclosure in accordance with the present invention is related to a method and a system for editing hyperlink within a three-dimensional scene. It is noted that editing the hyperlink includes creating, modifying, or deleting a hyperlink within the 3D scene. The technology of the present invention is implemented by software, hardware, or firmware operated in an intelligent device. The system is particularly implemented in a computer system that can be adapted to a handheld intelligent device. The intelligent device is such as a smart phone, a tablet, and even a virtual-reality glasses. The related software means allows a user to edit, including adding and eliminating, one or more hyperlinks within a 3D scene. The final production allows the user to use the hyperlinks to link other content when the user browses the 3D scene. The hyperlink renders linking a web page, linking another 3D scene, linking a correlated 3D scene within the same 3D scene, linking multimedia, executing a program, activating an animation or generating a message. Further, the system is not limited to browsing a single scene but may browse more than one 3D scene through the hyperlinks.

The hyperlink within the 3D scene is unnecessary to act as the traditional Universal Resource Locator (URL) used in a web page for linking to another URL. The conventional hyperlink used in the web page is represented by a hyperlink tag syntax embedded to the webpage script by an editor. For example, a syntax “<a href=”http:// . . . “>URL</a>” defines a conventional hyperlink. However, the method and system for editing a hyperlink within the 3D scene in the disclosure allows the user to intuitively edit the hyperlink by operating the intelligent device. For example, the user can move the intelligent device to browse the 3D scene within a space in order to decide an editing position. Alternatively, the system also allows the user to move the scene displayed on the intelligent device through its touch-sensitive display for deciding a position. The software assists the user to set up a hyperlink at the editing position. In the process of editing, a file is used to record the correlation between every specified position and its corresponding hyperlink. The correlation recorded in the file allows the user to effectively get an indication of the hyperlink for the specified position. It is noted that one 3D scene is permitted to have multiple hyperlinks. Further, a playback file is outputted after re-coding the 3D scene when all hyperlinks within the 3D scene are confirmed. This playback file can be a standard video file that allows the user freely to playback or to use in a common browser or a video player.

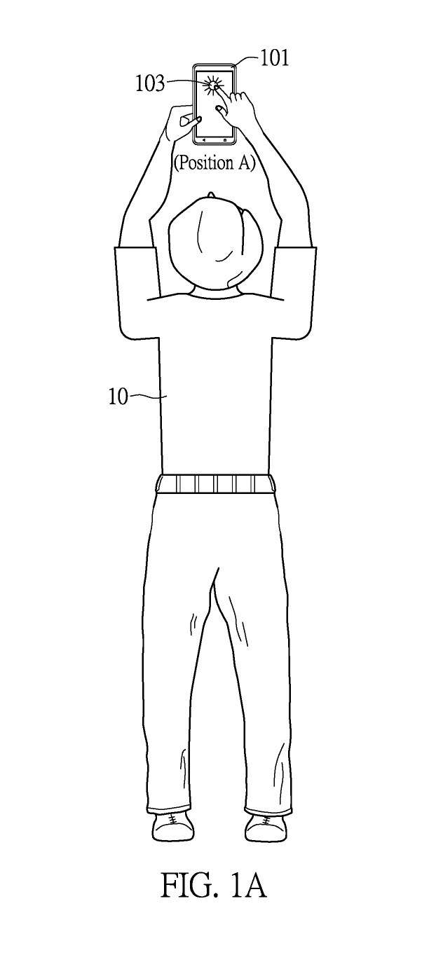

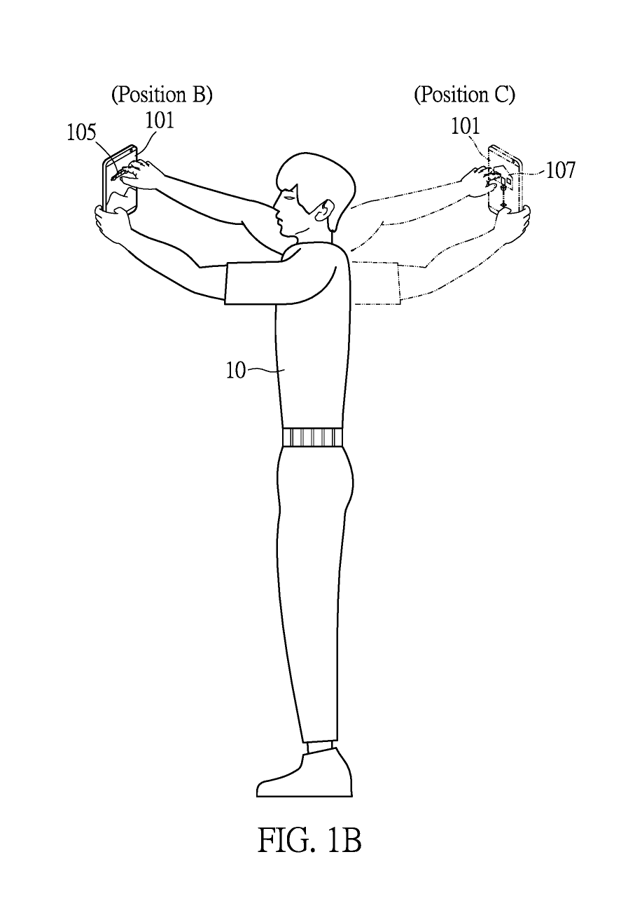

FIG. 1A and FIG. 1B shows a circumstance that a user uses an intelligent device to conduct the method for editing a hyperlink within a 3D scene in one embodiment of the present invention.

The 3D scene can be a three-dimensional virtual reality scene or an augmented reality scene that covers a full or a part of a virtual or real scene. The size of a 3D scene is generally larger than a display range of a display screen of the intelligent device. Therefore, the user is required to move the intelligent device within the space to browse the scene of interest. For viewing the 3D scene, the user can directly move the intelligent device to trigger generating the spatial positioning signals. Then the intelligent device can simultaneously display the 3D scene corresponding to the positioning signals based on a display resolution of the device. The user can use his finger to slide on the touch screen of the intelligent device for browsing the 3D scene. The 3D scene corresponds to a full or a part of a virtual or real three-dimensional space.

It is noted that the mentioned 3D scene is corresponding to full or part of a three-dimensional virtual or real scene. In one embodiment, a spatial sensor inside the intelligent device is incorporated to generate the positioning signals. The sensor is activated when the intelligent device is moved. The spatial sensor is such as a gyroscope that is generally used to generate the positioning signals in a 3D space. The spatial positioning signals are provided for this system to refer to the position of a hyperlink.

FIG. 1A shows a circumstance that a user 10 utilizes an intelligent device 101 to edit hyperlink. The circumstance shows the user 10 holding the intelligent device 101 for editing hyperlink at any position within a 3D space. An editing program for editing the 3D scene is installed in the intelligent device 101, and more particularly the editing program is such as a cellular application, e.g. APP, incorporated for editing hyperlink within the 3D scene. A 3D scene in first introduced to the program before editing. The 3D scene can be a scene covering every corner of a 360-degree space, or a scene covering a part of the 3D space e.g. non-360-degree space. The 3D scene can also be a scene exceeding a display range of the intelligent device 101. Any of the mentioned three-dimensional scenes can be displayed on the intelligent device 101 through the spatial positioning signals. The scenic image corresponding to the positioning signals is displayed on the display of the intelligent device 101 according to the user's operation of the intelligent device 101. It is noted that size and resolution of the display affect the content displayed on the display. Further, the playback program in the intelligent device 101 allows the user to decide a display ratio for viewing the 3D scene. It is also noted that a zooming tool allowing the user to set up the ratio can be used in the editing program.

In the present example, the user 10 moves the intelligent device 101 to a position above of the head of the user 10, e.g. position A, for editing. A touch-sensitive screen of the intelligent device 101 acts as a user interface for editing. At this moment, the display of the intelligent device 101 at the position A shows the scene above the user's head. The size, resolution and/or user's preferences of the screen of the intelligent device 101 result in a range to display the scene onto the screen. The editing program of the intelligent device 101 allows the user 10 to see the 3D scene corresponding to the positioning signals. Further, the touch-sensitive screen allows the user 10 to select a target position to be added/modified with a hyperlink in the scene through touch signals. Furthermore, the user 10 can touch on a first graphic object 103 such as the shown sun icon for editing (adding, modifying, deleting) the hyperlink associated to this first graphic object 103.

Further, the intelligent device used to edit hyperlinks within the 3D scene can be a smart phone or a head-mounted device such as virtual-reality glasses that allows the user to edit hyperlink within the virtual-reality scene or augmented reality scene using his gestures.

Reference is made to FIG. 1B showing a circumstance that a user 10 operates the intelligent device 101 at two positions B and C around a horizon for editing hyperlinks.

The user 10 holds the intelligent device 101 in his one hand and moves the device 101 within a three-dimensional space. Thus, a hyperlink can be edited at the position B. The diagram shows a second graphic object 105 is displayed on the intelligent device 101 for editing. The editing program first acquires the positioning signals of the intelligent device 101. The positioning signals can be the position information generated by a gyroscope inside the intelligent device 101 according to one of the embodiments of the present invention. The display shows a portion of the 3D scene corresponding to the positioning signals. The present example exemplarily shows a car icon where a hyperlink is edited, including adding, modifying or deleting the hyperlink. Correspondingly, the user 10 moves the intelligent device 101 to the position C and the editing program obtains the positioning signals at the position C. The display also shows a portion of the 3D scene corresponding to the positioning signals. A third graphic object 107 displayed on the display of the device 101 denotes the scene at the position C where the hyperlink is edited.

The aforementioned circumstances show the user 10 moves the intelligent device 101 to the position for editing since the spatial sensor inside the device 101 generates the positioning signals. Alternatively, the user can also utilize the touch-sensitive screen of the intelligent device 101 to select any editing position through finger gestures.

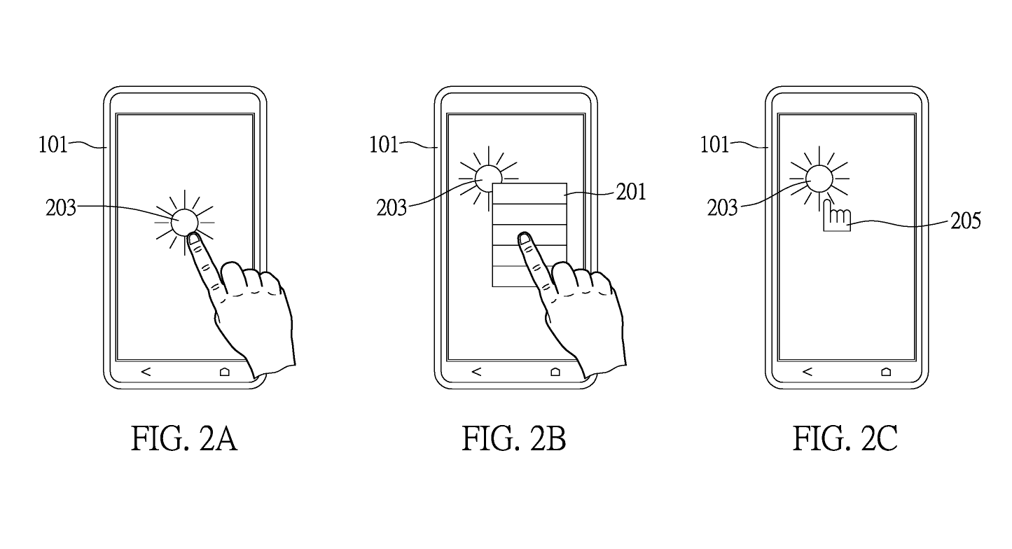

FIGS. 2A, 2B and 2C next show diagrams depicting the method for editing hyperlinks in the 3D scene using the intelligent device.

FIG. 2A shows a position specified within a 3D scene using the intelligent device 101. For example, the user moves the intelligent device 101 in up-down and left-right directions in the space for selecting a position to edit hyperlink. This example shows a graphic object 203 is selected, and a hyperlink associated with the graphic object 203 can be edited. It is noted that the hyperlink can be associated to any position of the specified scene.

When the user specifies a position through a gesture, such as the example shown in FIG. 2B, the touch signals generated through the touch-sensitive screen of the intelligent device 101 activate the editing program. The editing program exemplarily provides a hyperlink option. For example, a drop-down window 201 is rendered by the editing program for the user to select a method to establish a link to content associated with the hyperlink. The hyperlink content is especially concerning the graphic object 203. It is noted that every hyperlink within the 3D scene can be associated to a space position that can be irrelevant of any object, or can be made relevant to an object, e.g. the graphic object 203. For example, when a hyperlink is relevant to an object, e.g. the graphic object 203, the hyperlink will move along with its associated object when the object moves.

The hyperlink option, e.g. options listed in the drop-down window 201, includes one, or a combination of, linking a web page, linking another 3D scene, linking a correlated 3D scene within the same 3D scene, linking a multimedia content, executing a program, activating an animation, and producing a message.

Furthermore, in one embodiment of the present invention, a kind of hyperlink allows the user to enter another 3D scene from the present 3D scene rather than hyperlink to a web page, a multimedia file, or an animation within the same 3D scene. More particularly, in addition to the images of a three-dimensional space, the 3D scene can include whole content within the space. In other words, the 3D scene can be composed of a 3D space image covering a full or a part of a three-dimensional space, one or more pictorial objects, and all the hyperlinks associated to every space position and every pictorial object. Therefore, when the user enters or leaves any 3D scene using a browser, all the hyperlinks within the scene are maintained at the state they are in when the editing is done.

In one embodiment, multiple scenes can be switched through hyperlinks. It is noted that a hyperlink within a 3D scene can be established for linking to an associated 3D scene, and one 3D scene can include more than one associated 3D scene. For example, a 3D scene has a building, and a hyperlink can be inserted at an entrance of the building. This hyperlink forms an association with the entrance image. The related hyperlink content is another 3D scene inside the building, and this second 3D scene is one of the associated 3D scenes of the original 3D scene. In an exemplary example, the user can see several doors inside the building when the scene is switched to the building scene. Each of the doors is associated to a hyperlink. Thus the user can click any hyperlink associated to its associated door to enter the scene inside the door, and also come back to the scene of the building through the hyperlink at the other side. The present invention allows the user freely to switch between the 3D scenes.

When editing the hyperlink is accomplished, as shown in FIG. 2C, a marking can be used to indicate there is a hyperlink around the specified position. The present example shows a hand-shaped indication symbol 205 is formed around the position of the hyperlink. In the process of editing the hyperlinks, a file can be used to record the positions of the hyperlinks and their associated hyperlink contents. The system will store this setting when all operations to edit the hyperlinks are done. The indication symbol 205 assists the user acknowledging the graphic object 203 is associated to any hyperlink. It is noted that the indication symbol 205, not limited to the example shown in the diagram, can be a symbol, a picture, or text.

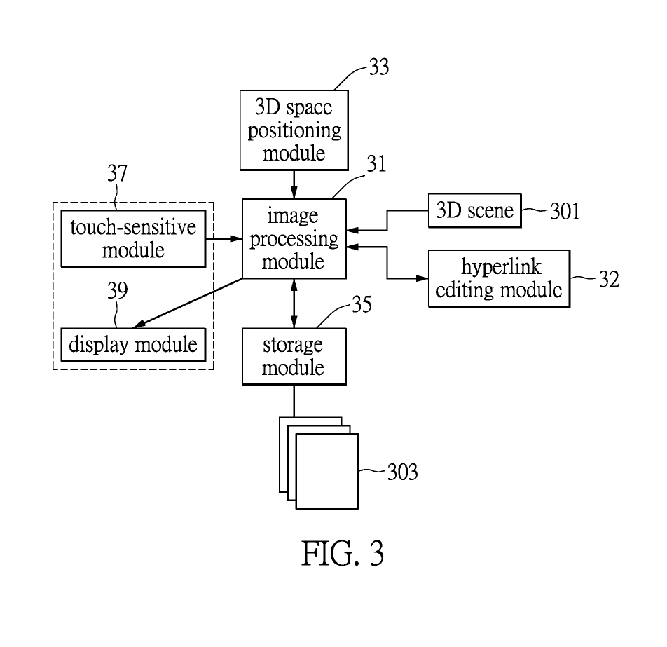

The system for editing hyperlink within the 3D scene can be implemented by software and/or hardware/circuit. FIG. 3 shows a block diagram depicting the software modules, or the functional modules made by the software module being collocated with circuits.

The system for editing hyperlink within the 3D scene can be operated in the intelligent device. The system can be implemented by a series of instruction set stored in the intelligent device. The system can also be made by a circuit system or an integrated circuit.

The system includes an image processing module 31, e.g. an image processor, or a CPU of a computer system, used to process the image signals of the 3D scene corresponding to the positioning signals in a space. The image processing module 31 is also used to process the images relating to the hyperlink. It is noted that the 3D scene 301 indicates images relating to virtual reality for specific space. The 3D scene 301 may also be a series of images of a real scene taken in advance. The 3D scene 301 may be a real-time 3D space image taken by a camera module of the intelligent device.

The image processing module 31 connects other functional modules such as a 3D space positioning module 33 that generates positioning signals based on a user's operation of the intelligent device. The positioning signals can be generated by gyroscope. Next, after the image processing module 31 processes the images, the signals are provided for a display module 39 to display the 3D scene according to a display resolution of the intelligent device. The 3D scene is simultaneously displayed on the intelligent device according to the positioning signals. The 3D scene can be a virtual or real scene corresponding to a full or a part of a 3D space.

In one embodiment of the present invention, the user can touch the touch-sensitive screen of the intelligent device to set up a hyperlink when he moves the intelligent device to a position. A series of touch signals corresponding to a specified position in the 3D scene are generated by a touch-sensitive module 37 of the system. A hyperlink editing module 32 is then activated to provide the function to edit the hyperlink. When the position to edit the hyperlink is specified, a display module 39 is used to display the scene around the specified position. A hyperlink option is incorporated for allowing the user to select one of the methods in a list to edit the hyperlink associated to the position. The hyperlink associated to the specified position is configured to link to a target content after the user completes the setting. The storage module 35 of the system stores this setting including the 3D scene and the hyperlink associated to the specified position within this scene.

The hyperlinks within the 3D scene allow the user to browse the scene in the future and also use the hyperlink to see further information. The 3D scene 301 with one or more hyperlinks including the associations can be encoded to a playback file. The stored data establishes a database 303.

It is noted that the 3D scene is essentially composed of a 3D space image, one or more pictorial objects, and one or more hyperlinks. Every hyperlink in the 3D scene 301 stored in the storage module 35 is associated to a position of the 3D scene 301, or to a pictorial object. The system allows the hyperlink associated to the pictorial object to change its position along with the pictorial object when this pictorial object is an animation moving in the scene.

For example, in the process to set up the hyperlink within a 3D scene, a text file or a file with specific format can be used to record the correlation of every hyperlink and its associated position or object. The file acts as a lookup table recording the coordinates of the specified position or object and its associated hyperlink. When all the hyperlinks within the 3D scene are confirmed, the scene and its hyperlinks with this file can be encoded to a playback file. This final file essentially includes the 3D scene image, a plurality of hyperlinks and their associated positions or objects, a plurality of indication symbols for the hyperlinks, a plurality of pictorial objects within the 3D scene. The content to be linked by the hyperlink can also be encoded to this file for specific purpose according to one of the embodiments.

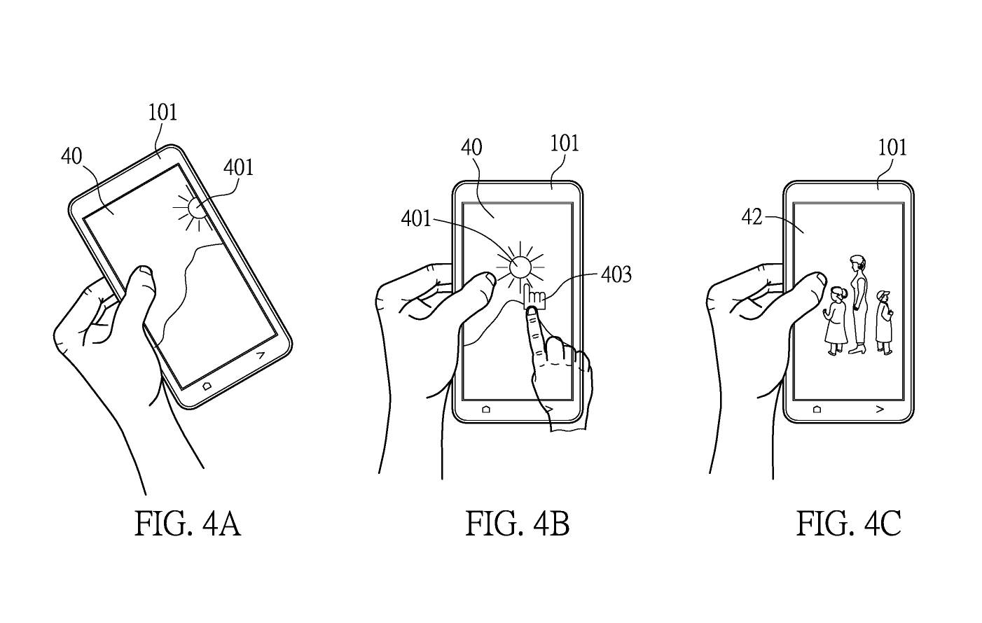

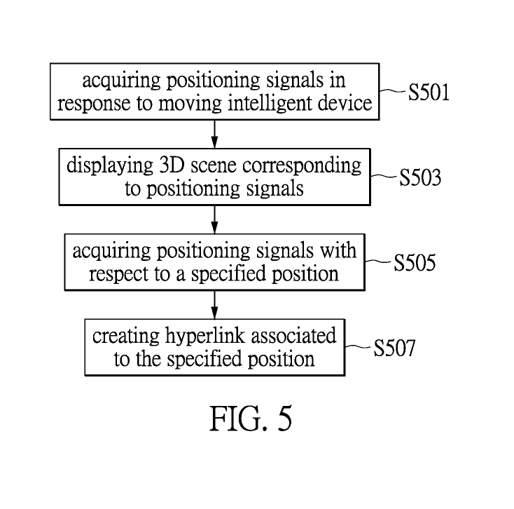

After completing the process for editing the hyperlinks within the 3D scene, the user can confirm the hyperlink by operating the intelligent device and use a playback program to browse this scene. References are made to FIGS. 4A, 4B and 4C schematically showing a circumstance where a user manipulates an intelligent device to browse the 3D scene.

According to this embodiment, a software means is employed to reproduce the 3D scene having the edited hyperlinks. The software means allows the system to acquire the positioning signals in response to moving the intelligent device 101. A portion of the 3D scene is displayed on the device in response to the positioning signals. The positioning signals also allow the system to acknowledge the position of images located in the 3D scene for editing or playing. The positioning signals assist the system in generating the corresponding images. It is also noted that the size and resolution of the display of the intelligent device 101 affects the display range of the scene. The user may also set up a display ratio of the scene based on his preference.

FIG. 4A shows an initial screen playing the 3D scene. A playback program can be provided to open a 3D scene playback file which prompts the user to browse the scene using an intelligent device 101. The positioning signals are simultaneously generated as moving the device in the space to browse the 3D scene. The portion of 3D scene to be displayed is based on the positioning signals.

Further, in FIG. 4A, the user moves the intelligent device 101 within a space of a first scene 40. It schematically shows the screen displaying a part of a graphic object 401 when the device is in a tilt angle. Next, in FIG. 4B, the graphic object 401 can be fully viewed in this first scene 40 through the playback program when the intelligent device 101 is moved to another space position. The graphic object 401 is shown at a middle position of the screen in this example, and a hand-shaped indication symbol 403 is also shown below the graphic object 401. The indication symbol 403 assists the user in recognizing that there is a hyperlink. When the user touches this indication symbol 403, as shown in FIG. 4C, the playback program switches the scene to a second scene 42 when it escapes from the first scene 40. The system allows the user to change scenes among a plurality of 3D scenes for the purpose of providing rich content and enhancing the browsing experience.

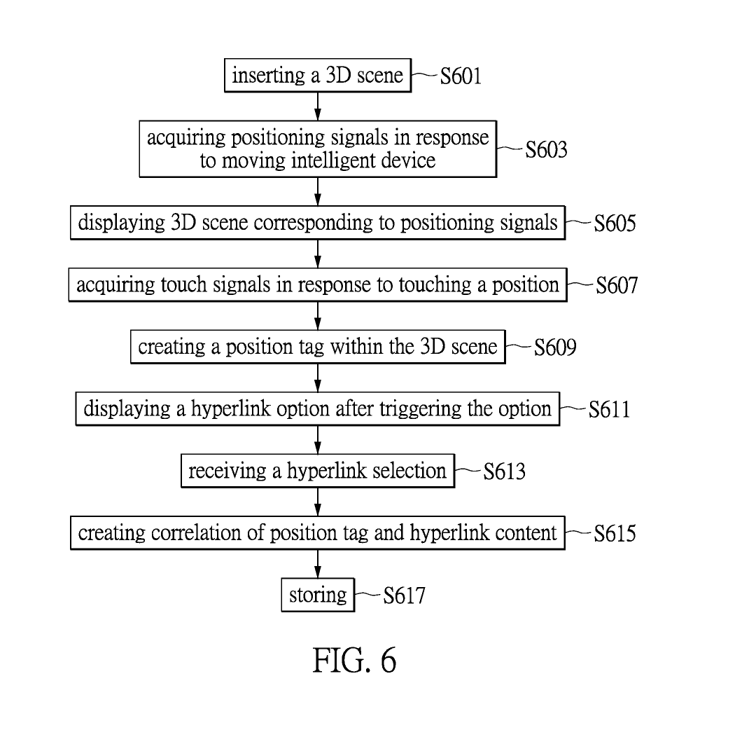

In one of the embodiments of the present invention, the software and/or hardware implemented system for editing hyperlink within the 3D scene further includes an editing instruction set and a playback instruction set stored in a memory of the intelligent device. The instruction sets can be implemented by a one single application, or several different applications. The instruction sets embody the procedures respectively described in the flow charts shown in FIGS. 5, 6 and 7.

In FIG. 5, a flow chart for describing a process for editing hyperlink within the 3D scene in one embodiment of the present invention is shown.

In the beginning of the process, such as in step S501, the system acquires positioning signals generated by a spatial sensor inside the intelligent device through the functions rendered by software and/or circuits. In step S503, a 3D scene corresponding to the positioning signals is displayed on a display of the intelligent device. A portion of the 3D scene can be displayed by the intelligent device based on not only the device's spatial orientation, but also the capability of the intelligent device to process the images. The capability of the intelligent device is based on size and resolution of the display. The size and resolution of the display of the intelligent device affect a display range and ratio of the image to be accurately displayed on the screen. Next, in step S505, the user intuitively operates the intelligent device to browse the 3D scene. The user can specify a position through a finger gesture or stylus over a touch-sensitive screen of the intelligent device. Positioning signals are simultaneously generated in response to the touch signals. After the position to be edited is specified, the software means renders an editing function for the user to edit a hyperlink associated to the position. Such as in step S507, the user can edit a hyperlink associated to this specified position, including creating a new hyperlink, modifying an existing hyperlink, or deleting a hyperlink.

FIG. 6 shows a further embodiment describing more details of the process for editing the hyperlink. An editing program is first executed in the intelligent device. The program may guide the user to import a 3D scene through an option. In step S601, a 3D scene is displayed on the screen of the intelligent device. An original image of the 3D scene can be a scene created from a real three-dimensional space, or a scene of 3D space transformed from a plane image. The 3D scene covers a full or a part of a 360-degree space. The user can intuitively operate the intelligent device to move within a three-dimensional space. In step S603, the editing program acquires positioning signals generated by the intelligent device. In step S605, the screen displays a portion of the 3D scene corresponding to the positioning signals in response to moving the intelligent device.

The user moves the intelligent device to decide a position for editing hyperlink by searching the 3D scene, e.g. a panoramic scene. In one embodiment, such as in step S607, the system allows the user to manipulate the intelligent device having a touch-sensitive screen. The user can select a position for editing the hyperlink through a finger gesture or any tool to touch the screen. For example, the user touches a position to create a new hyperlink, or touches a position to edit an existing hyperlink, and the editing program acquires the touch signals with respect to the position.

In step S609, a series of touch signals are generated by the touch-sensitive display for specifying the position. When the position is selected, a dialogue window is used to confirm the position with the user. A position tag associated to the 3D scene is created after the position is confirmed. In the meantime, such as in step S611, the system is triggered to show a hyperlink option. The hyperlink option is provided for the user to create a link to target content. The system may provide several methods to show the hyperlink option, for example the drop-down window shown in FIG. 2B is one of the methods. The user therefore selects one of the methods to make the hyperlink. The hyperlink option includes one, or a combination of, linking a web page, linking another 3D scene, linking a correlated 3D scene within the same 3D scene, linking a multimedia content, executing a program, activating an animation, and producing a message.

After one of the methods for creating the hyperlink is selected, such as in step S613, the software program receives the selection through the touch signals generated by the touch-sensitive screen. In step S615, the program is configured to create a correlation of the position tag and the hyperlink content. The position tag indicates a notation of a hyperlink within the 3D scene. According to one of the embodiments, after the hyperlink is created, an indication symbol used to indicate position of the hyperlink is created around the hyperlink, and also stored in a memory, such as in step S617.

In the present step of the process, a software interface can be rendered to guide the user to store the setting. In an exemplary example, the memory of the intelligent device can be used to store the 3D scene, the pictorial objects, and setting regarding the hyperlinks. A playback file can be created by encoding the 3D scene and the related content. The playback file may include the correlation indexes of the pictorial objects and their associated hyperlinks that allow the user to reproduce the 3D scene through a playback program.

The procedure described in FIG. 6 can be implemented by an application program. In one embodiment, the storage module 35 shown in FIG. 3 can be any storage means provided by the system. For example, a memory of the intelligent device or any type of storage is used to store an editing instruction set for performing the method for editing hyperlinks within the 3D scene of the present invention. The editing instruction set includes instructions for acquiring positioning signals generated by moving the intelligent device; instructions for using the intelligent device to display the 3D scene corresponding to the positioning signals; instructions for acquiring position information of the specified position within the 3D scene; and instructions for creating the hyperlink at the specified position. The editing instruction set, according to one of the embodiments, can further include instructions for using a file to record correlation between every specified position within the 3D scene and its corresponding hyperlink; and instructions for re-coding the 3D scene and outputting a playback file after all hyperlinks within the 3D scene are confirmed.

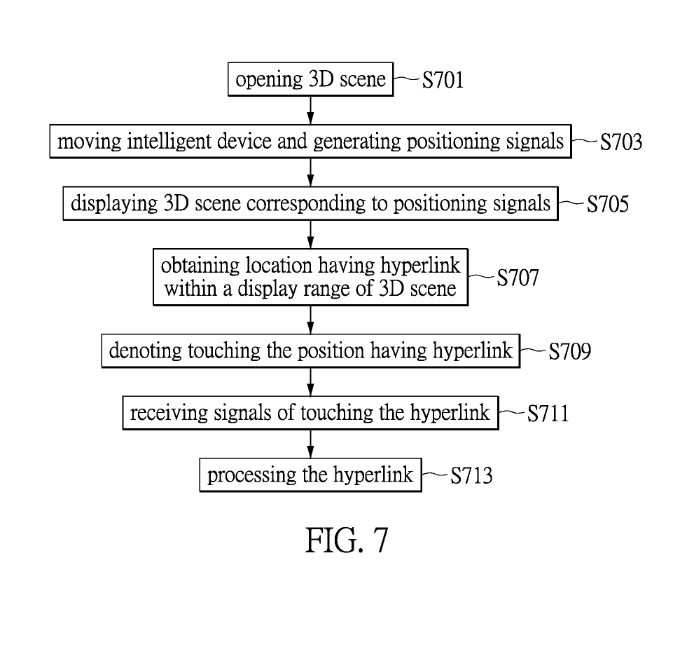

Next, in FIG. 7, a flow chart describing the process of browsing the 3D scene according to one embodiment of the present invention is shown.

A playback program is executed in the intelligent device. In step S701, the playback program guides the user to open a 3D scene. The user then moves the intelligent device within a space. The program simultaneously acquires positioning signals generated by the intelligent device, such as in step S703. The intelligent device displays a portion of the 3D scene corresponding to the positioning signal, such as in step S705. A display range of the 3D scene is based on not only the instant positioning signals, but also the display resolution of the intelligent device. The 3D scene denotes a full or a part of virtual or real three-dimensional scene.

The playback program allows the user to browse the 3D scene, and to find out the position or object with a hyperlink within a display range of the 3D scene, such as in step S707. As described in the previous embodiment, an indication symbol assists the user in acknowledging the position having a hyperlink, and also prompts the user to activate the hyperlink, such as in step S709. After a hyperlink is activated through the touch signals, the playback program receives the signals activing the hyperlink, such as in step S711, and the system processes the hyperlink and links to the associated content, such as in step S713.

The storage module also stores a playback instruction set, including instructions, in response to the positioning signals, for displaying the intelligent device within the 3D scene based on a display resolution of the intelligent device; instructions for introducing an indication symbol when the 3D scene having the hyperlink is displayed; and instructions, in response to touch signals, for triggering the hyperlink to link a web page, linking another 3D scene, linking a correlated 3D scene within the same 3D scene, linking a multimedia content, executing a program, activating an animation, or producing a message.

Thus, according to the above-described embodiments of the present invention, one of the objectives of the method and the system for editing hyperlink within a 3D scene is to provide a scheme allowing a user to intuitively operate an intelligent device to roam in a three-dimensional scene, and especially allowing the user to edit the hyperlink associated with a specific position intuitively. Reproducing the 3D scene, the system also allows the user to view the images within the 3D scene using the intelligent device. It also provides a mechanism where the hyperlinks allow the user the make a selection to link to the target content.

It is intended that the specification and depicted embodiment be considered exemplary only, with a true scope of the invention being determined by the broad meaning of the following claims.

What is claimed is:

1. A method for editing hyperlink within a 3D scene, comprising:
acquiring positioning signals generated by moving an intelligent device within a space;
using the intelligent device to display a 3D scene within a display range of the intelligent device corresponding to the positioning signals;
acquiring a position information of a specified position within the 3D scene; and
creating a hyperlink with respect to the specified position.

2. The method according to claim 1, wherein the 3D scene corresponding to the positioning signals is displayed on the intelligent device based on a display resolution; the 3D scene is corresponding to a full or a part of a virtual or real scene.

3. The method according to claim 1, wherein the positioning signals within the space are generated by a gyroscope built in the intelligent device when the intelligent device is moved.

4. The method according to claim 1, wherein the 3D scene is displayed on a touch-sensitive display of the intelligent device and position information of the specified position is generated from touch signals when the touch-sensitive display is touched.

5. The method according to claim 4, wherein the 3D scene corresponding to the positioning signals is displayed on the intelligent device based on a display resolution; the 3D scene is corresponding to a full or a part of a virtual or real scene.

6. The method according to claim 4, wherein, a hyperlink option used to select content to be linked is displayed on the touch-sensitive display after the position information of the specified position is acquired.

7. The method according to claim 6, wherein the hyperlink option includes one, or a combination of, linking a web page, linking another 3D scene, linking a correlated 3D scene within the same 3D scene, linking a multimedia content, executing a program, activating an animation, and producing a message.

8. The method according to claim 7, wherein the 3D scene corresponding to the positioning signals is displayed on the intelligent device based on a display resolution; the 3D scene is corresponding to a full or a part of a virtual or real scene.

9. The method according to claim 1, wherein, after the hyperlink is created, an indication symbol used to indicate position of the hyperlink is created around the hyperlink.

10. The method according to claim 9, wherein the 3D scene corresponding to the positioning signals is displayed on the intelligent device based on a display resolution; the 3D scene is corresponding to a full or a part of a virtual or real scene.

11. The method according to claim 10, wherein the 3D scene has one or more hyperlinks, in which every hyperlink is associated to a space position of the 3D scene, or to a pictorial object.

12. The method according to claim 11, wherein the 3D scene is essentially composed of a 3D space image, one or more pictorial objects, and one or more hyperlinks.

13. The method according to claim 12, wherein, a playback file is outputted after re-coding the 3D scene when all hyperlinks within the 3D scene are confirmed.

14. The method according to claim 13, wherein, in the process of editing the hyperlink, a file is used to record correlation between every specified position within the 3D scene and its corresponding hyperlink.

15. A system for editing hyperlink within a 3D scene, adapted to an intelligent device, wherein the intelligent device includes a storage module used to store a 3D scene, and a processor used to perform an editing instruction set with respect to a method for editing hyperlink within the 3D scene, the editing instruction set comprising:
instructions for acquiring positioning signals generated by moving the intelligent device;
instructions for using the intelligent device to display the 3D scene corresponding to the positioning signals;
instructions for acquiring position information of the specified position within the 3D scene; and
instructions for creating the hyperlink at the specified position.

16. The system according to claim 15, wherein the intelligent device utilizes a 3D space positioning module to acquire positioning signals within a space where the intelligent device is located; the intelligent device utilizes a display module to display the 3D scene on the intelligent device corresponding to the positioning signals based on a display resolution; the 3D scene is a virtual or real scene of all or part of a 3D space; and the intelligent device utilizes a touch-sensitive module to indicate a specified position with respect to the hyperlink within the 3D scene.

17. The system according to claim 16, wherein the 3D scene has one or more hyperlinks, in which every hyperlink is associated to a space position of the 3D scene, or to a pictorial object.

18. The system according to claim 17, wherein the 3D scene is essentially composed of a 3D space image, one or more pictorial objects, and one or more hyperlinks.

19. The system according to claim 16, wherein the editing instruction set includes:
instructions for using a file to record correlation between every specified position within the 3D scene and its corresponding hyperlink; and
instructions for re-coding the 3D scene and outputting a playback file after all hyperlinks within the 3D scene are confirmed.

20. The system according to claim 19, wherein the storage module further comprises a playback instruction set having:
instructions, in response to the positioning signals, for displaying the intelligent device within the 3D scene based on a display resolution of the intelligent device;
instructions for introducing an indication symbol when the 3D scene having the hyperlink is displayed; and
instructions, in response to touch signals, for triggering the hyperlink to link a web page, linking another 3D scene, linking a correlated 3D scene within the same 3D scene, linking a multimedia content, executing a program, activating an animation, or producing a message.
